(19) United States
(12) Patent Application Publication
(10) Pub. No.: US 2021/0403385 A1
(43) Pub. Date: Dec. 30, 2021

(54) SINTERED POLYCRYSTALLINE CUBIC BORON NITRIDE MATERIAL

(71) Applicant: Element Six (UK) Limited, Oxfordshire (GB)

(72) Inventors: Antionette CAN, Oxfordshire (GB); Anne Myriam Megne MOTCHELAHO, Oxfordshire (GB); Miriam MIRANDA-FERNANDEZ, Oxfordshire (GB)

(21) Appl. No.: 16/490,152

(22) PCT Filed: Mar. 13, 2018
(86) PCT No.: PCT/EP2018/056168

§ 371 Date: Aug. 30, 2019

(30) Foreign Application Priority Data
Mar. 15, 2017 (GB) 1704133.6

(51) Int. Cl. C04B 35/5831; C04B 35/64; C22C 29/16; C22C 1/05

(52) U.S. Cl. CPC C04B 35/5831; C04B 2235/6567; C22C 29/16; C22C 1/051; C04B 2235/386; C04B 2235/3856; C04B 2235/3843; C04B 2235/3886; C04B 2235/3813; C04B 2235/3865; C04B 2235/3217; C04B 2235/5445; C04B 2235/5436; C04B 2235/5472; C04B 2235/666; C04B 35/64

(57) ABSTRACT

A method of making a polycrystalline cubic boron nitride (PCBN), material is provided. The matrix precursor powder comprises an aluminium compound. The method comprises mixing matrix precursor powder comprising particles having an average particle size no greater than 250 nm, with between 30 and 40 volume percent of cubic boron nitride (cBN) particles having an average particle size of at least 4 μm, and then spark plasma sintering the mixed particles. The spark plasma sintering occurs at a pressure of at least 500 MPa, a temperature of no less than 1050° C. and no more than 1500° C. and a time of no less than 1 minute and no more than 3 minutes.

### FIELD

The invention relates to the field of sintered polycrystalline cubic boron nitride materials, and to methods of making such materials.

### BACKGROUND

Polycrystalline super hard materials, such as polycrystalline diamond (PCD) and polycrystalline cubic boron nitride (PCBN) may be used in a wide variety of tools for cutting, machining, drilling or degrading hard or abrasive materials such as rock, metal, ceramics, composites and wood-containing materials.

Abrasive compacts are used extensively in cutting, milling, grinding, drilling and other abrasive operations. They generally contain ultrahard abrasive particles dispersed in a second phase matrix. The matrix may be metallic or ceramic or a cermet. The ultrahard abrasive particles may be diamond, cubic boron nitride (cBN), silicon carbide or silicon nitride and the like. These particles may be bonded to each other during the high pressure and high temperature compact manufacturing process generally used, forming a polycrystalline mass, or may be bonded via the matrix of second phase material(s) to form a sintered polycrystalline body. Such bodies are generally known as PCD or PCBN, where they contain diamond or cBN as the ultra-hard abrasive, respectively.

U.S. Pat. No. 4,334,928 teaches a sintered compact for use in a tool consisting essentially of 20 to 80 volume % of cubic boron nitride; and the balance being a matrix of at least one matrix compound material selected from the group consisting of a carbide, a nitride, a carbonitride, a boride and a silicide of a IVa or a Va transition metal of the periodic table, mixtures thereof and their solid solution compounds. The matrix forms a continuous bonding structure in a sintered body with the high pressure boron nitride interspersed within a continuous matrix. The methods outlined in this patent all involve combining the desired materials using mechanical milling/mixing techniques such as ball milling, mortars and the like.

Precursor powders for the matrix phase are milled to reduce their particle size in order to be more intimately mixed and improve the bonding between them, as smaller particles are more reactive. However, a typical sintering process for PCBN uses a temperature of at least 1100° C. and a pressure of at least 3.5 GPa to form a PCBN material. Under these conditions, grain growth can occur and the particle size of some of the matrix particles can increase greatly, to have a size of typically up to 1 μm. This has a detrimental effect on the properties of the resultant PCBN.

### SUMMARY

It is an object to provide a sintered PCBN material with a more uniform matrix grain size to give improved tool properties.

According to the invention, there is provided a method of making a polycrystalline cubic boron nitride, PCBN, material. The method comprises mixing matrix precursor particles comprising particles having an average particle size no greater than 250 nm, the matrix precursor powder comprising an aluminium compound, with between 30 and 40 volume percent of cubic boron nitride, cBN, particles having an average particle size of at least 4 μm. The mixed particles are subjected to spark plasma sintering at a pressure of at least 500 MPa, a temperature of no less than 1050° C. and no more than 1500° C. and a time of no less than 1 minute and no more than 3 minutes.

As an option, the pressure is at least 1 GPa.

As an option, the temperature is selected from any of no more than 1400° C. and no more than 1300° C.

As an option, the time is no more than 2 minutes.

The method optionally further comprises ramping up to the temperature at a heating rate of between 100 and 500° C. per minute.

As an option, the matrix material further comprises titanium compounds of any of carbon and nitrogen.

As an option, the matrix material comprises any of titanium carbonitride, titanium carbide, titanium nitride, titanium diboride, aluminium nitride and aluminium oxide.

The step of mixing the matrix powder and the cBN powder optionally comprises any of wet acoustic mixing, dry acoustic mixing and attrition milling.

The method optionally comprises providing cBN particles with an average size between 0.2 and 15 μm.

The method optionally comprises providing cBN particles with an average size selected from any of greater than 1 μm and greater than 4 μm.

The method optionally comprises providing cBN particles having a multi-modal average size distribution.

### BRIEF DESCRIPTION OF DRAWINGS

Non-limiting embodiments will now be described by way of example and with reference to the accompanying drawings in which:

FIG. 1 is a graph of tool life for PCBN tools sintered at 5.5 GPa and 6.8 GPa under H15 conditions;

FIG. 2 is a graph of tool life for PCBN tools sintered at 5.5 GPa and 6.8 GPa under H10 conditions;

FIG. 3 is a scanning electron micrograph of a PCBN sample sintered at 6.8 GPa and 1300° C.;

FIG. 4 is a scanning electron micrograph of a PCBN sample sintered at 5.5 GPa and 1300° C.;

FIG. 5 is a flow diagram illustrating pre-compaction steps;

FIG. 6 shows an XRD traces of low cBN samples sintered at different temperatures;

FIG. 7 shows an XRD traces of high cBN samples sintered at different temperatures;

FIG. 8 shows heavy interrupted tool life of high cBN samples sintered at different temperatures;

FIG. 9 shows XRD spectra of exemplary PCBN materials prepared by spark plasma sintering;

FIG. 10 shows XRD spectra of further exemplary PCBN materials prepared by spark plasma sintering;

FIG. 11 shows Vickers Hardness data for Examples 35 to 43;

FIG. 12 shows Vickers Hardness data for Examples 44 to 53;

FIG. 13 shows density data for Examples 35 to 43;

FIG. 14 shows density data for Examples 44 to 53;

FIG. 15 shows hardness data for Examples 53 to 58 and 63 to 68 sintered using SPS at 80 MPa;

FIG. 16 shows hardness data for Examples 59 to 62 and 69 to 72 sintered using SPS at 1 GPa;

FIG. 17 shows Raman spectra for various samples; and

FIG. 18 is a scanning electron micrograph prepared by spark plasma sintering at 1 GPa.

### DETAILED DESCRIPTION

It has been found that, when using fine grained matrix precursor powders, with a d90 of less than 100 nm (when measured using a linear intercept technique), the use of very high pressures during sintering limits grain growth during the sintering process.

Using the linear intercept method, a random straight line is drawn though a micrograph and a number of grain boundaries intersecting the line are counted. The average grain size is found by dividing the number of intersections by the actual line length. Averaging the results using more than one random line improves the accuracy of the results. The average grain size is given by:

$$average grain size = \frac{line length}{number intersections}$$

For the purpose of this analysis, five horizontal lines and 5 vertical lines were analysed for each image to obtain a linear intercept average grain size.

Similarly, spark plasma sintering (SPS) under certain conditions has also been found to limit grain growth. Limiting grain growth is advantageous because smaller grains in the matrix phase improve properties of tools made from PCBN. Such properties include increased tool and reduced crater wear.

Considering first PCBN made using a high pressure high temperature (HPHT) technique, it has been found that for a given sintering temperature, a higher pressure improves performance. This is thought to be owing to a combination of grain growth inhibition and more effective sintering due to accelerated mass transport during the sintering process.

A 55 vol % 1.3 μm cBN content powder composition with a matrix phase of TiC_{0.5}N_{0.5} Al was prepared via an attrition milling powder processing route. Powder was pressed into metal cups at about 8 tonnes to create 17 mm diameter green bodies and sintered in a belt type high pressure high temperature apparatus.

The powders were sintered using five different sintering cycles, as shown in Table 1. For each sintering cycle, a holding time at the highest temperature of 19 minutes was used.

TABLE 1

| Sample | Pressure | Temperature |
|---|---|---|
| Example 1 | 6.8 GPa | 1300° C. |
| Example 2 | 6.8 GPa | 1450° C. |
| Example 3 | 5.5 GPa | 1300° C. |
| Example 4 | 5.5 GPa | 1450° C. |
| Example 5 | 5.0 GPa | 1300° C. |

The sintered materials were analysed by X-ray diffraction (XRD) and scanning electron microscopy (SEM) and found to be well-sintered. For the Examples 1 and 3, 10×10 mm square samples, 3.2 mm thick were prepared with edge chamfers and honing to produce tools for moderately interrupted (so-called H15) hard part machining testing. Slightly more continuous conditions were employed (so-called H10 interrupted machining) and the same samples were tested under these conditions with 20 passes being run on the workpiece and the crater wear greatest depth (Kt) being measured as an indication of so-called chemical wear.

Continuous machining is defined by a tool in continuous contact with a workpiece for a continuous period of time, resulting in heat and pressure generation at the tool tip. This engagement with the workpiece results in cutting action which removes workpiece material in chips, which flow across the surface of PCBN tool top surface, known as the rake face. Through various mechanisms including oxidation of the cBN, hBN formation and mass transport from the PCBN matrix phases into the workpiece, the PCBN tool wearing on the rake face of the tool is known as crater wear. Due to proposed mechanisms of wear being mainly diffusional and chemical in nature, the crater wear is often synonymous with chemical wear. In applications where there is a higher degree of continuous machining, lower cBN contents in the PCBN used to machine these workpieces often perform better compared with higher cBN content materials. This is related to hBN formation and oxidation of the cBN in contact with hardened steel workpieces, under the high temperature conditions at the tool-workpiece interface.

Many cutting operations require a tool to machine parts in continuous and interrupted modes. The gaps or spaces in the workpiece geometry are known as interrupts and the ratio of the length of interrupt to continuous machining, together with the engagement angle, determine the degree of interrupt in the machining operation.

An interrupted scale of 1-40 is defined by the continuous applications being on the 1-5 range, 10-20 represent a moderate interrupt in the workpiece and 25-40 represent more aggressive interrupted conditions.

In moderately interrupted applications (H15/H20), the chemical wear results in deep crater formation, which creates a sharp edge at risk of chipping when the PCBN tool encounters a gap or interrupt in the workpiece being machined. This poses a great challenge for moderately interrupted applications, where the success of the PCBN tool depends on a balance between chemical wear resistance and impact resistance or strength.

Moderately interrupted machining tests (in the H15 region on the interrupted scale) were carried out using AlSl4340 hardened steel workpieces, with six drilled holes in them, at a surface cutting speed of 150 m/minute, with a feed rate of 0.15 mm/revolution and depth of cut 0.2 mm. PCBN tool edges were prepared to SNMN090308 S0220 sample edge specifications, with a 20 micron hone.

Low interrupted machining tests (in the H10 region on the interrupted scale) were carried out using similar conditions to the H15 test but using a three-hole face rather than a six-hole face.

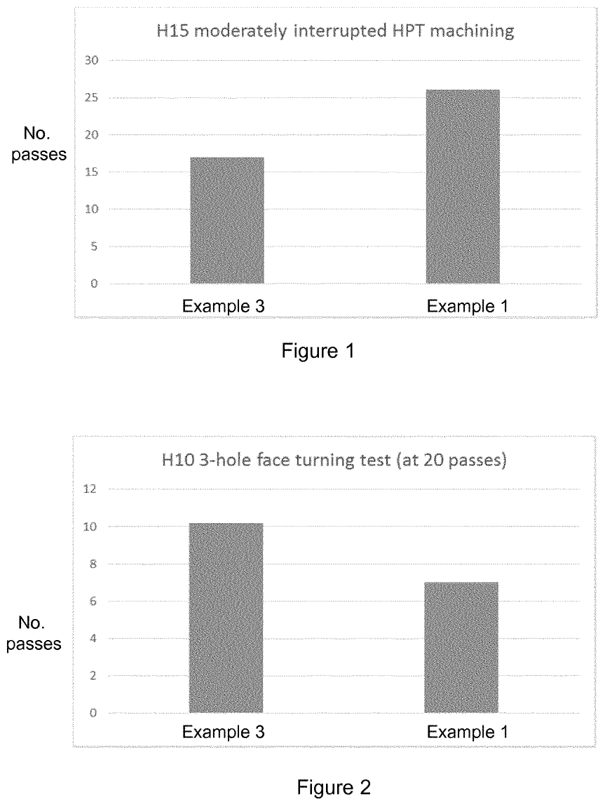

FIG. 1 compares the tool life of Examples 1 and 3 when tested using H15 conditions in a six-hole drilling test. This shows that Example 1, which was sintered at a higher pressure than Example 3, out-performed Example 3 by about 50%.

FIG. 2 compares the crater wear of Examples 1 and 3 when tested using H10 conditions in a three-hole drilling test. This shows that Example 1, which was sintered at a higher pressure than Example 3, had significantly lower crater wear.

The Scherrer calculation method was used to relate the breadth of XRD peaks to the size of the crystallites in the matrix phase for Examples 1 to 5. Results shown in Table 2 indicated that temperature was the most significant factor influencing crystallite size of the ceramic matrix. However, it can also be seen that the lowest crystallite size was obtained when sintering at the highest pressure. It can be seen that temperature has more effect on crystallite size than pressure. Note that the crystallite size may be smaller than the grain size, as a sintered grain may consist of more than one crystallite.

TABLE 2

| | | Position | | Crystallite size |
|---|---|---|---|---|
| Sample | Temperature | (°2θ) | FWHM | (nm) |
| Example 1 | 1300° C. | 49.288 | 0.5 | 26 |
| Example 2 | 1450° C. | 49.3272 | 0.382 | 37 |
| Example 3 | 1300° C. | 49.2827 | 0.472 | 28 |
| Example 4 | 1450° C. | 49.2628 | 0.394 | 35 |
| Example 5 | 1300° C. | 49.3058 | 0.468 | 28 |

30 vol % cBN and 45 vol % cBN content powder in a Ti_{0.5}N_{0.5} Al matrix compositions were prepared via an attrition milling powder processing route. Powder was pressed into metal cups at about 8 tonnes to create 17 mm diameter green bodies and sintered in a belt type high pressure high temperature apparatus.

Three different sintering cycles and two different cBN contents were employed to sinter these powders, as shown in Table 3. For each example, the samples were held at maximum temperature for 19 minutes.

TABLE 3

| Sample | cBN vol % | Pressure | Temperature |
|---|---|---|---|
| Example 6 | 30 | 6.8 GPa | 1300° C. |
| Example 6a | 45 | 6.8 GPa | 1300° C. |
| Example 7 | 30 | 6.8 GPa | 1450° C. |
| Example 7a | 45 | 6.8 GPa | 1450° C. |
| Example 8 | 30 | 5.5 GPa | 1300° C. |
| Example 8a | 45 | 5.5 GPa | 1300° C. |

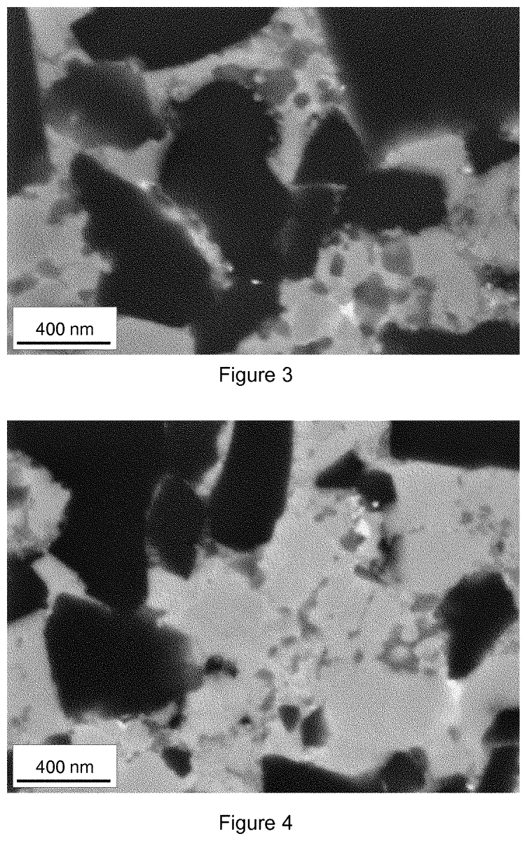

FIG. 3 is a scanning electron micrograph of Example 6a, and FIG. 4 is a scanning electron micrograph of Example 8a. The black particles are cBN and the paler particles are matrix grains. It can be seem that Example 8a, sintered at the same temperature but a lower pressure than Example 6a, appears to have a wider spread of large matrix grains that have grown during sintering. It can be inferred that the use of higher pressure during sintering restricts the growth of larger matrix grains.

These samples analysed using an SEM to estimate particle size distributions of the ceramic matrix phases. Table 4 shows the average particle size of the matrix phase of selected examples.

TABLE 4

| | % of matrix | % of matrix | Matrix |
|---|---|---|---|
| Sample | grains <50 nm | grains >50 nm, <100 nm | grains <100 nm |
| Example 1 | 50.0 | 28.6 | d79 |
| Example 6 | 37.6 | 29.3 | d67 |
| Example 6a | 38.3 | 27.2 | d66 |
| Example 7a | 45.5 | 29.5 | d75 |
| Example 8a | 35.2 | 22.7 | d58 |
| Example 9 | 11.7 | 32.5 | d44 |

It can be seen from Table 4 that temperature has the largest effect of matrix phase grain size, but higher pressures can alleviate this effect.

Three further variations were planned to develop a high pressure synthesis route for PCBN. These variation concentrated upon material composition and methods of pre-compaction (compaction prior to sintering). Pre-compaction was necessary to ensure that there was a minimized change in volume during the final sintering. If density was not maximised before sintering, then increased shrinkage may have led to a decrease in pressure while sintering, resulting in conversion of cBN to hexagonal boron nitride (hBN) and cracking of the samples.

Two variants of powder composition were chosen, one high cBN content and one low cBN content. The high content variant (Example 9) was 90 wt % cBN with an average particle size of 10 μm and 10 wt % aluminium, with an average particle size of 6 μm. 81 g of 10 μm cBN and 9 g of aluminium were mixed using a resonance acoustic mixer at 80 G for 2 minutes.

The lower content variant (Example 10) was 60 vol % cBN, with an average particle size of 1.3 μm with a ceramic based matrix of TiC_{0.5}N_{0.5} with a 10% by mass addition of aluminium to the TiC_{0.5}N_{0.5} as a sintering aid. Powders were mixed in three stages using dry acoustic mixing with Resodyn Acoustic mixing equipment. First a matrix premix of 3.9 g aluminium and 35.0 g TiCN, followed by a mixing of 42.2 g 1.3 μm cBN. The matrix mix was then added to the cBN pot and then mixed again. All mixes were performed at 80 G for 2 minutes.

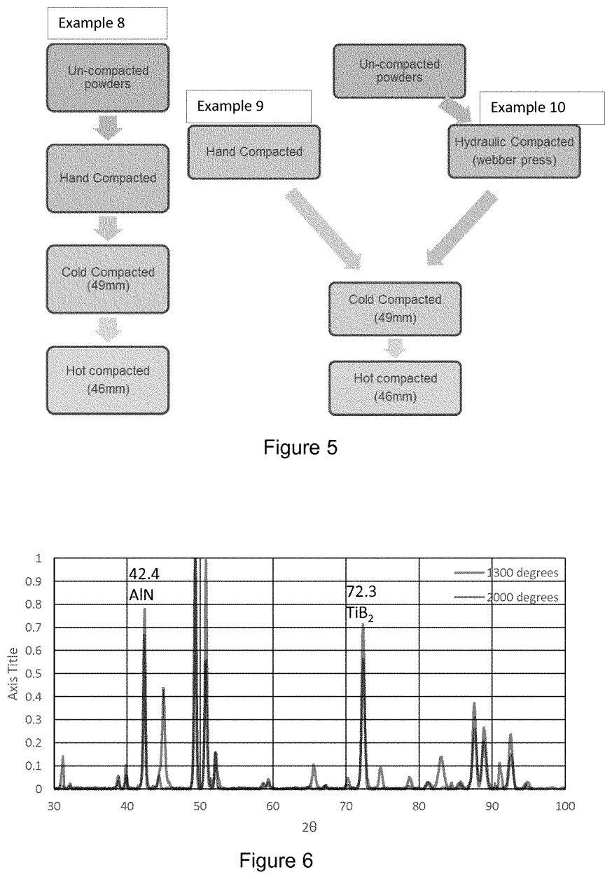

Three routes were chosen for pre-compaction resulting in a three-step process: Hand compaction into ceramic cups, cold compaction in a cubic press then finally hot compaction again in a cubic press. However with the lower cBN content variant (Example 10), hydraulic compaction was trialled prior to cold compaction, therefore differentiating Example 10 (hand compaction) and Example 11 (hydraulic compaction). The compaction steps are summarised in FIG. 5.

Hydraulic compaction achieved a green body density of 2.42 g/cm³.

The ceramic cups were placed in an outer envelope and pressed using a cubic press without any direct heating as to avoid sintering at this stage. The samples were pressed at 600 MPa. Samples were extracted and then hot compacted at 1300° C., 1800° C. and 2000° C. under a pressure of about 7 GPa.

When measuring density after hot compaction, Example 9 had a final density of 3.36 g/cm³ and Examples 10 and 11 had a final density of 3.67 g/cm³. The higher density is a result of the ceramic TiC_{0.5}N_{0.5} matrix and its higher density.

Slugs were removed from their hBN cups by grinding. The resultant cylinders were then ground to a smooth finish. Following this, they were sliced into discs using a rotating spindle and a laser. Discs were lapped to 3.2 mm in height and 10×10 mm squares were cut for wear tests. An additional piece was cut to be polished for SEM analysis.

In the case of Examples 10 and 11, the slugs broke apart when removed for the cups. These pieces were not recoverable for wear tests but small pieces were analysed through SEM.

Using sintered pieces, X-ray diffraction spectra were obtained, as shown in FIGS. 4 and 5. Owing to the difference binder chemical compositions of Example 9 compared with Examples 10 and 11, it was not possible to make direct comparisons. However using similar materials sintered at lower temperatures as references some conclusions could still be drawn.

The sintering temperature alters the rates at which the cBN reacts with the matrix phases. In the case of Examples 10 and 11, shown in FIG. 6, it can be seen that when the sintering temperature is increased, boride phases become prevalent, possibly due an increased rate of diffusion of boron into the matrix phases. This is also indicated by the reduced presence of the cBN peak at 50.7° 2θ. There is also a reduction in the relative intensity of AlN at higher temperature, potentially in favour of Al forming a boride.

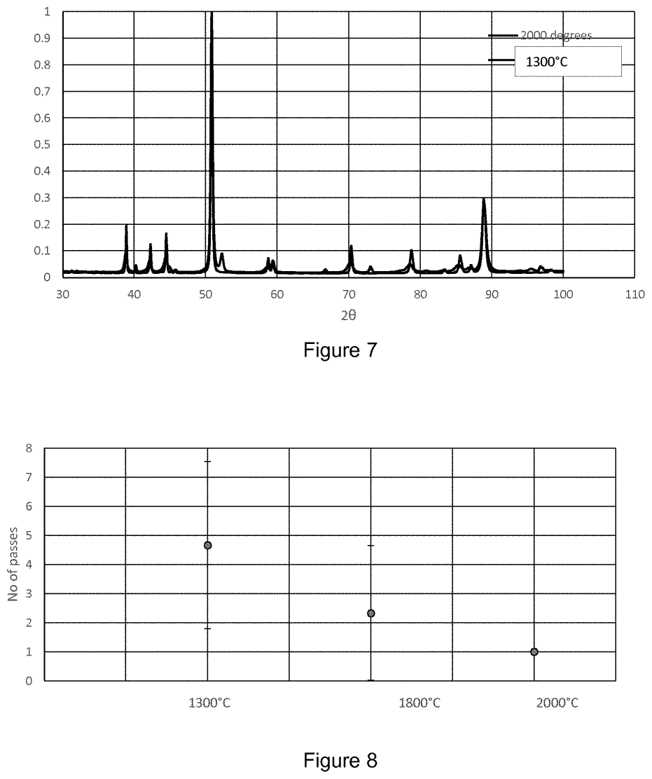

FIG. 7 shows the XRD spectrum of Example 9 sintered at 1300° C. and 2000° C. Very few differences can be seen here, except for a large increase in the formation of AlN. Boride phases were not detected.

FIG. 8 shows the tool life of Example 9 sintered at 1300° C., 1800° C. and 2000° C. when tested under highly interrupted conditions using a feed rate of 0.3 mm, a depth of 0.2 mm, a cutting speed of 180 m/min and a workpiece material of D2 tool steel. Samples made from material sintered at 2000° C. suffered tool fracture after just 1 pass. This highly brittle behaviour may be due to extensive reactions in the matrix phase and excessive grain growth.

It has been found that sintering at high temperature can alter the chemical composition of PCBN. It has further been shown that sintering of large volume PCBN is possible if the necessary pre-compaction steps are taken to reduce the collapse during final sintering.

Spark Plasma Sintering (SPS) is a technique that allows rapid sintering of PCBN. Pulsed DC current is applied to a green body, allowing for very high heating and cooling rates. The rapidity of the process allows rapid densification while minimizing grain growth during the sintering process. A further advantage of SPS when applied to PCBN is that the rapidity reduces the conversion of cBN to hBN that would otherwise happen at relatively low pressures (less than 3 GPa).

Initial experiments were carried out which showed that SPS sintered samples with cBN content more than about 30 vol % and finer than 5-10 μm resulted in significant hBN formation.

Table 5 shows exemplary data for PCBN prepared using SPS at a pressure of 80 MPa, and Table 6 shows exemplary data for PCBN prepared using SPS at a varying pressures. All of the samples show cBN vol % in a matrix of 85 weight % TiC/15 weight % Al, and were carried out on a sample size of 20 mm for the 80 MPa samples and 6 mm for the other samples.

TABLE 5

| | | | | 1350 cm⁻¹ | 1350 cm⁻¹ |
|---|---|---|---|---|---|
| | | | Den- | hBN | hBN |
| | Powder | | sity | signal | signal |
| Example | cBN | Sintering | (gcm⁻³) | edge | middle |
| 12 | 45% 1.3 | 100° C./ | 4.27 | hBN | hBN |
| | μm | min 1500° C. | | | |
| 13 | 30% 1.3 | 500° C./ | 4.04 | hBN | hBN |
| | μm | min 1650° C. | | | |
| 14 | 30% 1.3 | 500° C./ | 4.09 | hBN | hBN |
| | μm | min 1750° C. | | | |
| 15 | 30% 1.3 | 500° C./ | 4.03 | Large | hBN |
| | μm | min 1850° C. | | hBN | |
| 16 | 45% 1.3 | 500° C./ | 4.13 | | |
| | μm | min 1650° C. | | | |
| 17 | 45% 1.3 | 500° C./ | 4.01 | hBN | hBN |
| | μm | min 1750° C. | | | |
| 18 | 30% 1.3 | 500° C./ | 3.96 | hBN | hBN |
| | μm | min 1850° C. | | | |
| 19 | 30% 10 | 500° C./ | 4.42 | Small | No |
| | μm | min 1650° C. | | hBN | hBN |
| 20 | 30% 10 | 500° C./ | 4.06 | Large | hBN |
| | μm | min 1750° C. | | hBN | |
| 21 | 30% 10 | 500° C./ | 3.89 | Large | hBN |
| | μm | min 1850° C. | | hBN | |

The percentage of cBN in the powder is given as a volume %.

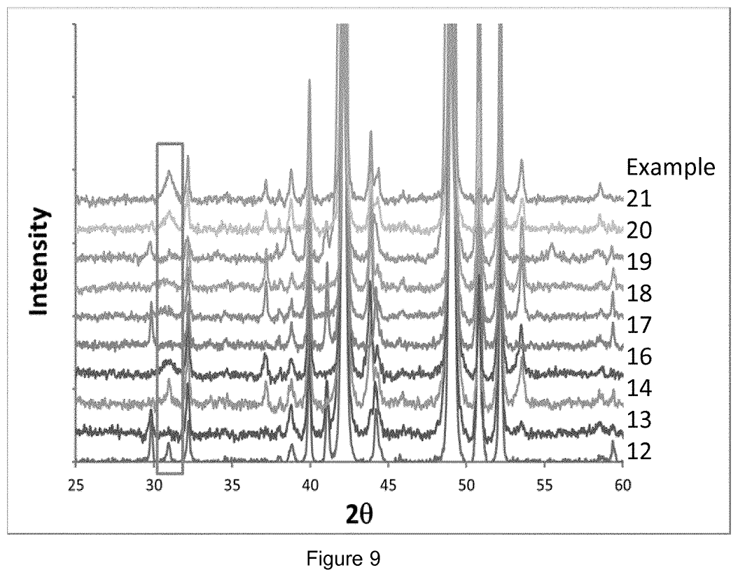

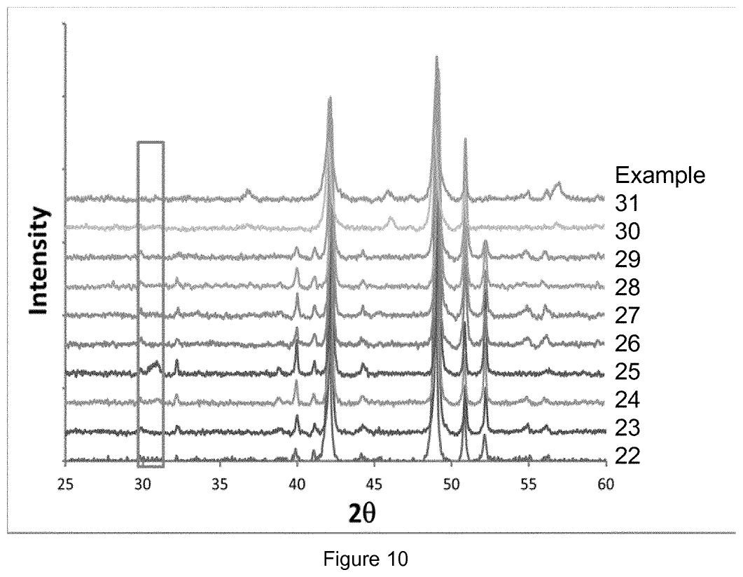

FIG. 9 shows XRD spectra for Examples 12 to 21. The peak around 31° 2θ arises from the hBN phase, showing that some conversion of cBN to hBN has occurred. Furthermore, the density data shown in Table 5 illustrate both the degree of densification during the SPS process and also formation of hBN, as hBN has a density of around 2.1 gcm⁻³ and cBN has a density of around 3.45 gm⁻³; a lower density therefore indicates a higher degree of hBN conversion.

TABLE 6

| | | | | 1350 cm⁻¹ | 1350 cm⁻¹ |
|---|---|---|---|---|---|
| | | | Den- | hBN | hBN |
| | | | sity | signal | signal |
| Example | Powder | Sintering | (gcm⁻³) | edge | middle |
| 22 | 30% 1.3 | 100° C./ | 4.27 | hBN | hBN |
| | μm cBN | min 1220° C. | | | |
| | | 0 minutes | | | |
| | | 750 MPa | | | |
| 23 | 30% 1.3 | 1325° C. 5 | 4.37 | Large | hBN |
| | μm cBN | mins 600 MPa | | hBN | |
| 24 | 30% 1.3 | 1400° C. 7 | 4.21 | hBN | hBN |
| | μm cBN | mins 600 MPa | | | |
| 25 | 30% 1.3 | 1500° C. 7 | 4.24 | Large | hBN |
| | μm cBN | mins 600 MPa | | hBN | |
| 26 | 30% 1.3 | 1450° C. 5 | 4.18 | | |
| | μm cBN | mins 800 MPa | | | |
| 27 | 45% 1.3 | 1300° C. 5 | 4.11 | Large | hBN |
| | μm cBN | mins 800 MPa | | hBN | |
| 28 | 45% 1.3 | 1400° C. 5 | 4.10 | hBN | hBN |
| | μm cBN | mins 800 MPa | | | |
| 29 | 45% 1.3 | 1480° C. 5 | 4.22 | hBN | hBN |
| | μm cBN | mins 800 MPa | | | |
| 30 | 45% 1.3 | 1220° C. 5 | 4.57 | hBN | Small |
| | μm cBN | mins 1 GPa | | | hBN |
| 31 | 30% 10 | 1220° C. 5 | 4.51 | | |
| | μm cBN | mins 1 GPa | | | |
| 32 | 30% 10 | 920° C. 1 | 4.35 | Small | Small |
| | μm cBN | min 1 GPa | | hBN | hBN |
| 33 | 30% 10 | 850° C. 5 | 4.27 | Small | No |
| | μm cBN | mins 1 GPa | | hBN | hBN |
| 34 | 30% 1.3 | 1110° C. 5 | 4.32 | hBN | hBN |
| | μm cBN | mins 1 GPa | | | |

The time given in the third column of Table 6 is the time at which the material was held at the maximum temperature, and the % of cBN in column 2 is given as volume %.

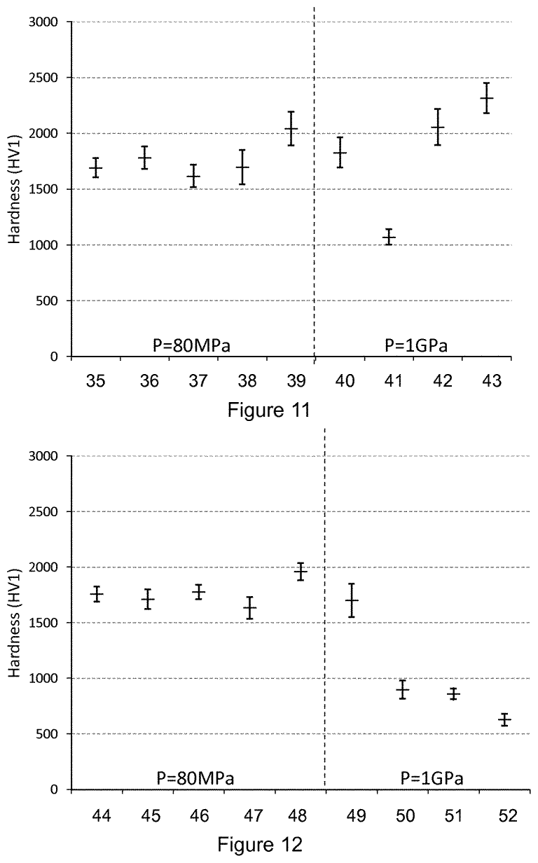

Given the results of the PCBN compacts reported in Tables 5 and 6 and FIGS. 11 and 12, cBN content was subsequently kept no higher than 30 vol % and an average particle size of 10 μm was used. The times and pressures of sintering were varied as shown in Table 7.

TABLE 7

| | Temp. | | | | Heating | Release |
|---|---|---|---|---|---|---|
| | max | | | Time | rate | pressure |
| Ex | (° C.) | Pressure | | (min) | (° C./min) | (° C.) |
| 35 | 1650 | 80 | MPa | 2 | | |
| 36 | 1650 | 80 | MPa | 0 | | |
| 37 | 1650 | 80 | MPa | 1 | | |
| 38 | 1550 | 80 | MPa | 1 | | |
| 39 | 1550 | 80 | MPa | 2 | | |
| 40 | 1000 | 1 | GPa | 1 | 100 | 700 |
| 41 | 900 | 1 | GPa | 5 | 100 | 700 |
| 42 | 1050 | 1 | GPa | 3 | 100 | 700 |
| 43 | 1200 | 1 | GPa | 1 | 100 | 700 |
| 44 | 1650 | 80 | MPa | 2 | | |
| 45 | 1650 | 80 | MPa | 0 | | |
| 46 | 1650 | 80 | MPa | 1 | | |
| 47 | 1550 | 80 | MPa | 1 | | |
| 48 | 1550 | 80 | MPa | 2 | | |
| 49 | 1150 | 1 | GPa | 0 | 100 | 700 |
| 50 | 1050 | 1 | GPa | 0.5 | 100 | 700 |
| 51 | 1200 | 1 | GPa | 0 | 100 | 700 |
| 52 | 1050 | 1 | GPa | 0 | 100 | 700 |

Examples 35 to 52 used 30 volume % cBN. Examples 35 to 43 were prepared with a matrix of 30:70 mol Ti:Al+85% (0.5:0.5 mol TiN:TiC), and Examples 44 to 52 were prepared using a matrix of 2:3 mol Ti:Si (metal powders) and 85% TiN/TiC. For Example 51, the heating rate was changed to 200° C./minute between the temperatures of 1000° C. and 1200° C.

FIG. 11 shows Vickers Hardness data for Examples 35 to 43, and FIG. 12 shows Vickers Hardness data for Examples 44 to 53. It can be seen from FIG. 11 that higher pressures improve the hardness, probably as a result of the improved densification, whereas higher pressure in FIG. 12 lowered the hardness. This is thought to be caused by the different binder chemistry; in this cause the formation of residual silicon compounds may make the material more brittle.

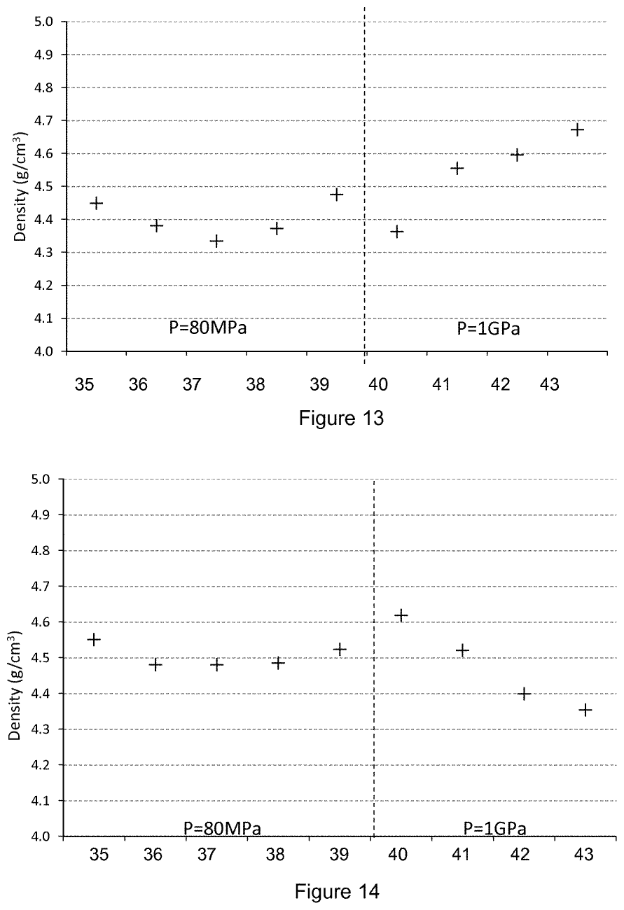

FIG. 13 shows density data for Examples 35 to 43, and FIG. 14 shows density data for Examples 44 to 53. The trends correspond to the hardness trends shown in FIGS. 13 and 14.

A 30 vol % cBN content powder, comprising cBN particles with an average particle size of 10 μm was prepared by attrition milling routes. The composition of the matrix material was 85 wt % Ti(C_{0.5}N_{0.5})_{0.8} and 15 wt % of a combination of 70 mol % Al/30 mol % Ti. The matrix material was first heat treated at 1050° C. in vacuum, followed by 4 hours of attrition milling in hexane. The cBN was added into the attrition milling mixture and mixed for a further 10 minutes.

The final mixture was dried and sintered in a graphite cupping configuration in an SPS press capable at two different pressure levels; 80 MPa and 1 GPa. The heating rates used were 100° C./minute and the cooling rates 200° C./minute. Different times and maximum temperatures of SPS were used, as shown in Table 8:

TABLE 8

| | Pressure | Top temp | Time at top |
|---|---|---|---|
| Example | (MPa) | ° C. | temperature (min) |
| 53 | 80 | 1450° C. | 2 |
| 54 | 80 | 1500° C. | 2 |
| 55 | 80 | 1550° C. | 2 |
| 56 | 80 | 1450 | 3 |
| 57 | 80 | 1500 | 3 |
| 58 | 80 | 1550 | 3 |
| 59 | 1000 | 1200 | 1 |
| 60 | 1000 | 1300 | 1 |
| 61 | 1000 | 1400 | 1 |
| 62 | 1000 | 1500 | 1 |

In order to compare a different matrix chemistry, a 30 vol % cBN content powder, comprising cBN particles with an average particle size of 10 μm was prepared by attrition milling routes. The composition of the matrix material was 85 wt % of a combination of 30 mol % TiC_{0.8} and 70 mol % TiN_{0.7}, together with 15 wt % of a combination of 70 mol % Al/30 mol % Ti. The matrix material was first heat treated at 1050° C. in vacuum, followed by 4 hours of attrition milling in hexane. The cBN was added into the attrition milling mixture and mixed for a further 10 minutes.

The final mixture was dried and sintered in a graphite cupping configuration in an SPS press capable at two different pressure levels; 80 MPa and 1 GPa. The heating rates used were 100° C./minute and the cooling rates 200° C./minute. Different times and maximum temperatures of SPS were used, as shown in Table 9:

TABLE 9

| | Pressure | Top temp | Time at top |
|---|---|---|---|
| Example | (MPa) | (° C.) | temperature (min) |
| 63 | 80 | 1450 | 2 |
| 64 | 80 | 1500 | 2 |
| 65 | 80 | 1550 | 2 |
| 66 | 80 | 1450 | 3 |
| 67 | 80 | 1500 | 3 |
| 68 | 80 | 1550 | 3 |
| 69 | 1000 | 1200 | 1 |
| 70 | 1000 | 1300 | 1 |
| 71 | 1000 | 1400 | 1 |
| 72 | 1000 | 1500 | 1 |

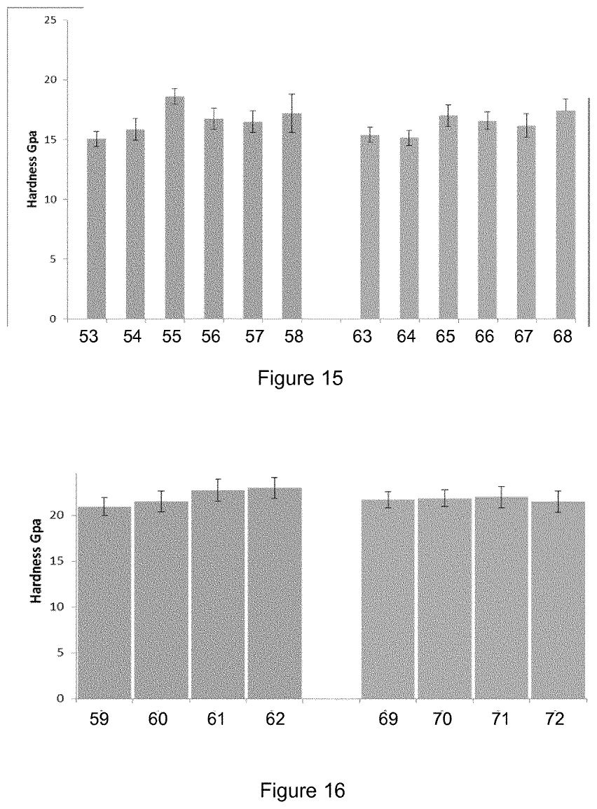

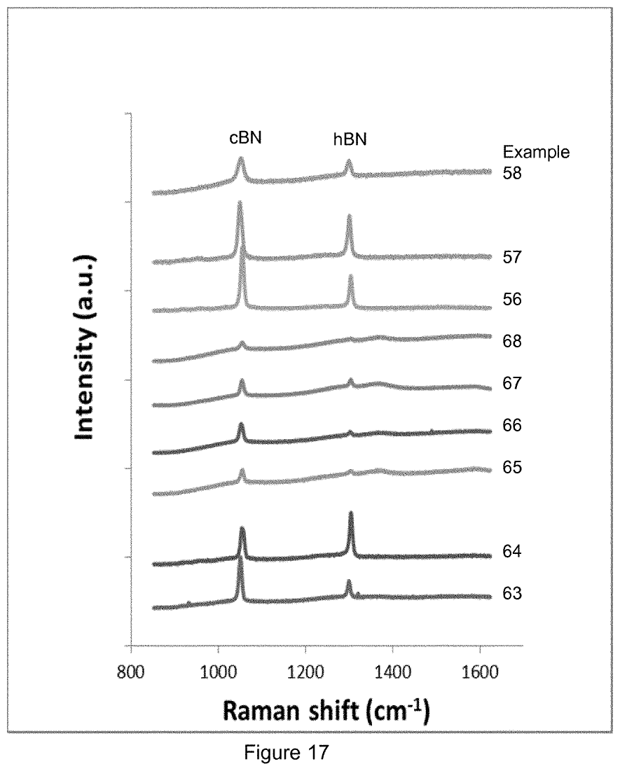

FIG. 15 shows hardness data for Examples 53 to 58 and 63 to 68 sintered using SPS at 80 MPa. FIG. 16 shows hardness data for Examples 59 to 62 and 69 to 72 sintered using SPS at 1 MPa. FIG. 17 shows Raman spectra for various samples. It appears that SPS using higher pressure (1 GPa) at a moderate temp (1000° C. to 1200° C.) limits hBN formation, leading to improved density and hardness.

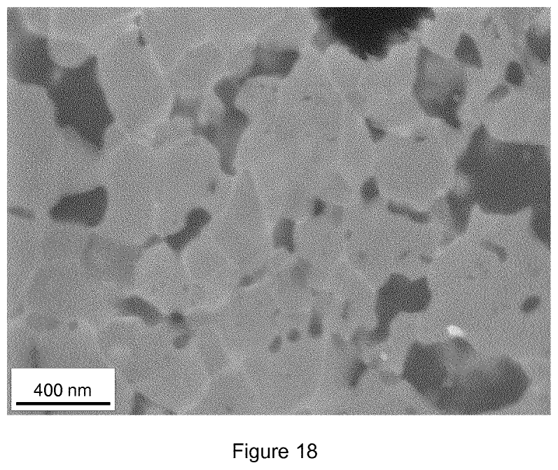

FIG. 18 is a scanning electron micrograph of Example 62, showing a uniform distribution of grains. Table 10 below shows matrix grain size selected examples.

TABLE 10

| | % of matrix | % of matrix | Matrix |
|---|---|---|---|
| Sample | grains <50 nm | grains >50 nm, <100 nm | grains <100 nm |
| Example 42 | 31.4 | 21.9 | d52 |
| Example 62 | 34.7 | 21.8 | d57 |

Note that Example 61 and 43 were tested using an oscillating sliding test under dray conditions with a ball-on-disc configuration to measure wear rate, along with a similar reference sample of 45 vol % cBN sintered in an HPHT process at 1350° C., 5.5 GPa. It was found that the reference sample had a wear rate of 1.51×10⁻⁷ mm³/Nm, whereas Example 43 had a wear rate of 3.23×10⁻⁸ mm³/Nm and Example 61 had a wear rate of 2.51×10⁻⁸ mm³/Nm. The SPS samples therefore had a significantly lower wear rate than the reference sample.

In general, it has been found that for both HPHT and SPS sintering, lower temperatures inhibit grain growth. However, high pressure has been found to improve density and also play a part in inhibiting grain growth and enabling sintering at lower temperatures while still inhibiting hBN conversion. When using SPS, lower cBN content and coarser (>5 μm) cBN particles have been found to reduce conversion of hBN to cBN.

Note that Al (either in metallic or pre-reacted form) may be coarse (>100 nm) in the matrix precursor powder for safety reasons, leading to a higher d90 value in the precursor powder. However, during sintering the Al melts and subsequently solidifies with a lower particle size. For this reason, the starting powders can have a higher d90 value than the resultant grain size of the matrix.

### Definitions

As used herein, PCBN material refers to a type of super hard material comprising grains of cBN dispersed within a matrix comprising metal or ceramic.

As used herein, a “PCBN structure” comprises a body of PCBN material.

A “matrix material” is understood to mean a matrix material that wholly or partially fills pores, interstices or interstitial regions within a polycrystalline structure. The term “matrix precursor powders” is used to refer to the powders that, when subjected to a high pressure high temperature sintering process, become the matrix material.

A multi-modal size distribution of a mass of grains is understood to mean that the grains have a size distribution with more than one peak, each peak corresponding to a respective “mode”. Multimodal polycrystalline bodies may be made by providing more than one source of a plurality of grains, each source comprising grains having a substantially different average size, and blending together the grains or particles from the sources. In one embodiment, a PCBN material may comprise cBN grains having a multimodal distribution.

While this invention has been particularly shown and described with reference to embodiments, it will be understood by those skilled in the art that various changes in form and detail may be made without departing from the scope of the invention as defined by the appended claims. For example, although all of the examples use cBN as the superhard phase, it will be appreciated that the same techniques may be used for other types of superhard materials dispersed in a matrix material.

1. A method of making a polycrystalline cubic boron nitride, PCBN, material, the method comprising:
mixing matrix precursor powder comprising particles having an average particle size no greater than 250 nm, the matrix precursor powder comprising an aluminium compound, with between 30 and 40 volume percent of cubic boron nitride, cBN, particles having an average particle size of at least 4 μm;
spark plasma sintering the mixed particles at a pressure of at least 500 MPa, a temperature of no less than 1050° C. and no more than 1500° C. and a time of no less than 1 minute and no more than 3 minutes.

2. The method according to claim 1, wherein the pressure is at least 1 GPa.

3. The method according to claim 1 or 2, wherein the temperature is selected from any of no more than 1400° C. and no more than 1300° C.

4. The method according to claim 1 or 2, wherein the time is no more than 2 minutes.

5. The method according to claim 1 or 2, further comprising ramping up to the temperature at a heating rate of between 100 and 500° C. per minute.

6. The method according to claim 1 or 2, wherein the matrix material further comprises titanium compounds of any of carbon and nitrogen.

7. The method according to claim 1 or 2, wherein the matrix material comprises any of titanium carbonitride, titanium carbide, titanium nitride, titanium diboride, aluminium nitride and aluminium oxide.

8. The method according to claim 1 or 2, wherein the step of intimately mixing the matrix powder and the cBN powder comprises any of wet acoustic mixing, dry acoustic mixing and attrition milling.

9. The method according to claim 1 or 2, comprising providing cBN particles with an average size between 0.2 and 15 μm.

10. The method according to claim 1 or 2, comprising providing cBN particles with an average size selected from any of greater than 1 μm and greater than 4 μm.

11. The method of making a PCBN material according to claim 1 or 2, comprising providing cBN particles having a multi-modal average size distribution.
